(19) United States
(12) Patent Application Publication
(10) Pub. No.: US 2025/0197626 A1
(43) Pub. Date: Jun. 19, 2025

(54) BASE COMPONENT WITH A BULK MOLDED COMPOUND AND NO BASE COAT

(71) Applicant: Valeo Vision, Bobigny (FR)

(72) Inventors: Robert Fraizer, Auburn Hills, MI (US); Scott Adaska, Troy, MI (US)

(21) Appl. No.: 18/541,599

(22) Filed: Dec. 15, 2023

(51) Int. Cl. C08L 33/12; C08J 7/04; C08K 3/013; C08K 7/14

(52) U.S. Cl. CPC C08L 33/12; C08J 7/04; C08K 3/013; C08K 7/14; C08J 2333/12; C08J 2433/12; C08L 2205/025; C08L 2207/20

(57) ABSTRACT

A body composition with: a bulk molded compound (BMC) with: one or more thermoset resins; one or more fillers; one or more reinforcements; one or more binders; two or more inhibitors; and recycled body composition materials (recycled BMC); wherein the recycled BMC is a cured material that is processed and added into the body composition.

### FIELD

The present teachings relate to a component that comprises a bulk molded compound and no base coat where the base component includes inhibitor, recycled material, or both so that the base component is smooth, has little to no shrinkage, is free of flash, or a combination thereof.

### BACKGROUND

Vehicles include many different types of lights. Some types of lights included on a vehicle are low beam headlights, high beam headlights, taillights, turn signal lights, fog lights, running lights, or a combination thereof. Each of these lights extend out of an outer surface of a vehicle so that they provide light for the driver or provide notice to surrounding drivers. These light systems generally direct light outward from the vehicle. These lights may include a reflector that spreads the light across a predetermined region. These reflectors may be made by injection molding.

Thus, there is a need for a base component that is free of shrinkage. There is a need for a material that when formed is smooth. There is a need for a material that does not flash when injected into a mold. It would be desirable to have a bulk molded compound that that may be free of distortions along a surface of the base component when molded.

### SUMMARY

The present teachings provide: a body composition comprising: a bulk molded compound (BMC) comprising: one or more thermoset resins; one or more fillers; one or more reinforcements; one or more binders; two or more inhibitors; and recycled body composition materials (recycled BMC); wherein the recycled BMC is a cured material that is processed and added into the body composition.

The present teachings provide: a lighting component comprising: a body component comprising: a body composition comprising: a bulk molded compound resin (BMC); one or more fillers; two or more inhibitors; and recycled body composition materials (recycled BMC); wherein the recycled BMC is cured material of the body composition that is processed and added into the body composition.

The present teachings provide: a process comprising: forming a bulk molded compound (BMC) comprising: one or more thermoset resins; one or more fillers; one or more reinforcements; and one or more binders; combining the bulk molded compound with recycled body composition materials (recycled BMC), that has been cured, to form a body composition; molding the body composition into a body component of a lighting component; and curing the BMC.

The present teachings provide a base component that is free of shrinkage. The present teachings provide a material that when formed is smooth. The present teachings provide a material that does not flash when injected into a mold. The present teachings provide a bulk molded compound that that may be free of distortions along a surface of the base component when molded.

### BRIEF DESCRIPTION OF THE DRAWINGS

FIG. 1 is a side view of a vehicle including a light system.

FIG. 2 is an isometric view of a base component.

FIG. 3 is a top plan view of a base component.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings relate to a light system. The light system is located within a vehicle. Preferably, the light system is part of a vehicle such as a car, motorcycle, bus, truck, semi-truck, SUV, XUV, four-wheeler, dirt bike, tractor, combine, heavy equipment, farm equipment, industrial equipment, commercial equipment, or a combination thereof. The light system may project light in a forward direction, rear direction, side direction, vertical direction (e.g., z-axis), from a fore to an aft, an aft to a fore, or a combination thereof. Preferably, the light system projects a light from an external surface of the vehicle to a location in front of the vehicle or at an angle relative to the front or rear of a vehicle.

The light system may direct some light at the ground. The light system may direct some light above the ground. The light system may be integrated into a front end, a rear end, or both of a car. The light system may be an assembly. The light system may be a sealed light system that is integrated into a vehicle. The light system may be a sub-assembly that is included in a larger light system. The light system may be integrated into another light system and may function to be part of the light system. The light system may project light out of the vehicle. The light system may include multiple different lights or light sub-systems that each provide a different function. The light systems may be multiple light systems or light sources stacked one above the other, side by side, within different planes, within a same plane and projecting in different direction, integrated into a single light system, or a combination thereof. The light system may have multiple smaller light systems or light sources. The light systems may include a body and the body may be covered by one or more outer lenses or may be free of an outer lens.

The outer lens may form an outer most surface of the light system. The outer lens may function to protect all or a portion of the light system. The outer lens may be free of covering a lighting component. The outer lens may cover the lights.

The plurality of light systems or lights may be located in one light system or one or more components. The plurality of light systems may operate independently of one another such that one light system may not affect another light system or portion of the light system. The light system may provide light with two or more colors, three or more colors, four or more colors, or a combination thereof.

The light sources function to produce light, direct light towards a base component such as a reflector, or both. The light source may be a device or a plurality of devices that create light and the light extends outward from the light source. The light source may produce a high beam, a low beam, a blending beam, a running light, a daytime light, a turn signal, a brake light, a warning light, a communication, ornamentation, a signal, decoration, or a combination thereof. The light sources may have different functions. For example, one light source may provide a running light, another light source may be a turn signal, and another light source may provide a high beam or a low beam. The light source may comprise a plurality of lights or may be a single light source within a set of light sources. The plurality of lights may be in one set or group of light sources. The light source may be a single light that projects light. In another example, a light source may direct light in a first direction. The light sources may direct light in a first direction. The base component may direct light from the light sources in a second direction.

The light sources may be any type of lighting device that produces light such as an incandescent bulb, fluorescent light, compact fluorescent lamp, halogen lamp, light emitting diode (LED), high intensity discharge lamps (HID); halogen lights, xenon lights, a laser diode, phosphorous bulb, or a combination thereof. The light sources may be a single lamp or bulb. Preferably, the light sources are part of a set of light sources that include a plurality of lamps, bulbs, diodes, or a combination thereof. The light sources may be part of a set of light sources that includes 2 or more, 3 or more, 4 or more, 5 more, 7 or more, 9 or more, or 11 or more lights that produce light and combine together to form the light extending from the light system. The sets of light sources may include 20 or less, 18 or less, 16 or less, or 14 or less lights that produce light (e.g., each set may include 8 light sources or alternatively all of the sets when combined together may include 8 light sources or 2 light sources). For example, the set of light sources may be the contents of a single printed circuit board that perform a same lighting function and the set of light sources may be 8 lights.

The number of light sources in a part of the light system may dependent upon a size of the region to be illuminated or an amount of light to be provided. Thus, the light source may be one or more lights, two or more lights, or three or more lights. The light source may be static. The light sources may be free of movement. The light source may be fixed. The light sources may be static and may be manually or physically adjusted so that the light sources are directed to a desired location. The light sources may be fixed and the light from the light source may be moved, bent, directed, or a combination thereof by optical elements, textured portions, micro-optics, or reflectors (e.g., a substrate or a portion of a substrate). Each device (e.g., light or LED) of the light source may be turned on and off. The light sources may be illuminated in a sequence. The light source may be located within a light system at a location relative to a substrate, an edge of a substrate, a side of a substrate, or a combination thereof. The light sources may work together as a set of light sources to create light. All of the light sources may be a same color or provide a same color light. For example, all of the lights may be white or non-colored light. All of the light sources may be a single color light source.

The set of light sources function to fill a light bar, a lens, an outer housing, an outer lens, light blade, a substrate, an edge of a substrate, a side of a substrate, a reflector, a base component, or a combination thereof so that light projected outward to perform some function. The set of light sources may be a single function (e.g., a high beam, a low beam, a blending beam, a running light, a daytime light, a turn signal, a brake light, ornamentation, a display, signaling, or a combination thereof). Each set of light sources may perform a single function. The light sources may extend in a row, in a column, a straight line, or a combination of both. The light from the light sources may be directed outward from a vehicle so that the light is visible external of the vehicle. The light sources may be controlled my one or more controllers.

The controllers function to control the light sources or the lights within a light source individually. The controller may be part of the vehicle, part of the light system, or both. A single controller may control all of the lights. The controller may illuminate (e.g., fire) the lights in a sequence, individually, in a pattern, a predetermined manner, a predetermined sequence, randomly, or a combination thereof. The controller may be programmable, include pre-set programs, or both. The controller may be accessed inside of the vehicle so that the user can change the illumination settings of the light system. The controller may communicate with light sources through one or more printed circuit boards.

The light sources may be located on or connected to one or more printed circuit boards. The printed circuit boards (PCB) may provide power, signals, support, or a combination thereof to one or more light sources. The PCB may be fixed within a light system. Each PCB may be connected to a plurality of light sources. The PCB may be electrically connected, mechanically connected, or both to one or more light sources discussed herein, the base component, or both. The PCBs may aim the light from the light sources towards a portion of a base component. The PCBs may align light sources with base components, reflectors, or both. The PCBs may be connected to a base component (e.g., a body) of the light system.

The base component of the light system functions to connect the light system within a vehicle. The base component includes one or more light sources, two or more light sources, three or more light sources, or a plurality of light sources. The base component may direct light in a predetermined direction, redirect light in a predetermined direction, or both. The body may aim the lights within the light system, the vehicle, or both. The base component may be a central portion that all of the components connect to so that the light system when connected to a vehicle the light system functions. The base component may be directly connected to a printed circuit board, a controller, a micro-processor, or a combination thereof. The base component may be thermally connected to a printed circuit board, a controller, components on the printed circuit board, or a combination thereof. The printed circuit board, the controller, the light sources, or a combination thereof may be connected to the body.

The base component may reflect light, aim light, and dissipate heat. The base component may include a reflector portion, a heat sink portion, a heat dissipation portion, or a combination thereof. The base component may be a reflector a part of the housing, a support bracket, a connection bracket, a substrate of a reflector, a part of a reflector previously made of metal, or a combination thereof.

The base component may have a composition that may be made of or include a first composition of materials and the body composition may be covered one or more coatings. The composition may be sufficiently rigid to support the light system within a vehicle. The composition may sufficiently thermally conductive to dissipate heat to prevent thermal movement of the light system (e.g., movement from thermally expanding or thermally contracting). The composition may be or include one or more components that when combined together form the body.

The composition of the base component may include one or more bulk molded compounds (hereinafter BMC). The composition may be comprised substantially of BMC. The composition may be composed of about 40 percent or more, about 50 percent or more, about 60 percent or more, about 70 percent or more, about 80 percent or more, about 90 percent or more, or about 95 percent or more BMC of the total weight of the base component. The composition may be composed of about 99 percent or less, about 98 or less, 97 percent or less, 95 percent or less, about 93 percent or less, or about 90 percent or less of the total weight of the base component. The BMC may include glass fibers, styrene, an initiator, a shrink additive, inhibitors, a filler, a thermoset resin, calcium carbonate (CaCO₃), crushed glass, binder, polyester, recycled material, post-industrial recycled material, post-consumer recycled material, polymethyl methacrylate (PMMA), talcum powder, magnesium silicide (Mg₂Si), thermoset resin, unsaturated resin, release agent, catalyst, filler, reinforcement, thermoplastic resin, pigment, thickening agents, flash reducer, or a combination thereof.

The glass may be a recycled glass, The glass may be post-industrial, post-consumer, or both. The glass may be recycled in a similar manner as the other recycled materials (e.g., reduced in size, classified, and added to the composition). The glass may assist in reducing roughness of the base component. The glass may be added as a filler. The glass may be added into the resin.

The thermoset resin may be or include polyester, an unsaturated polyester, vinyl ester, epoxy, phenolic, or a combination thereof. The thermoset may react when cured to solidify the BMC. The thermoset resin may be about 3 percent or more, about 5 percent or more, about 7 percent or more, about 10 percent or more, or about 12 percent or more of the total weight of the base component (e.g., around 7 percent by weight). The thermoset may be about 30 percent or less, about 25 percent or less, about 20 percent or less, about 15 percent or less, about 13 percent or less, or about 35 percent or less of the total weight of the base component. The thermoset resin may be combined with filler, reinforcement, thermoplastic resin, or a combination thereof.

The resin may be one or more and preferably two or more different resins. The resins may be two different polyesters. The resins may be a BMC resin and a PMMA resin. The resins may have different bonding levels, different bonding timing, different bonding strengths, or a combination thereof. The different resins may provide different properties to the base component. The two or more resins may be added with inhibitors.

The inhibitors may be a free radical inhibitor. The inhibitors may delay a reaction of q free-radical catalyst during injection into a mold. The inhibitors may delay reaction for 1 second or 2 seconds after substantially all of the composition is provided to the mold cavity (e.g., 70% or more, 80% or more, 90% or more of the mold is filled). The inhibitors may delay crosslinking. The inhibitors may delay crosslinking until a mold is filled (e.g., 70% or more of the mold is filled). The inhibitors may be or include methyl ethyl ketone peroxide (MEKP), hydroquinone, 4,4-dihydroxybiphenyl, catechols, 3-n-alkyl, 3-isopropyl, 3-phenyl, 4-n-alkyl, 4-isopropyl, 3,5dialkyl, 3,6-dialkyl, hdroxylamines, p-phenylenediamines, ninitro-ortho-cresol, di-nitro-sec-butylphenol, 2,6-Di-tert-butyl-p-cresol, 4-methoxyphenol, 4-tert-butylpyrocatechol, tert-butylhydroquinone, 2-tert-butyl-1,4-benzoquinone, copper (II) Dibtyldithiocarbamate, 2,6-Di-tert-butylphenol, 2-[1-(Hydroxy-3,5-di-tert-pentylphenyl)ethyl]-4,6-di-tert-pentylphenyl Acrylate, phenothiazine, 1,1-Diphenyl-2-picrylhydrazyul free radical, 1,4-Benzoquinone, 6-tert-butyl-2,4-xylenol, or a combination thereof.

The inhibitors function to prevent curing the resins before the resins are moved to a desired location. The inhibitors may partially inhibit curing. The inhibitors may completely prevent curing. The inhibitors may prevent curing until the resins achieve a predetermined temperature. The inhibitors may prevent curing of the resins when the resins are at an injection temperature. For example, the resins may be at room temperature when the resins are injected into the mold and the inhibitors may prevent curing at room temperature. The inhibitors may maintain the resins in a viscous form so that the resins may flow. A first inhibitor (e.g., an injection inhibitor) may work at room temperature to prevent the components of the composition from curing while the composition is being mixed, created, or both. The first inhibitor may be a BMC inhibitor. The first inhibitor may prevent premature reactions at room temperature. The first inhibitor may be or include hydroquinone, 4,4-dihydroxybiphenyl, toluhydroquinone, X-butylhydroquinones, or a combination thereof. The first inhibitor may inhibit a reaction while the composition is waiting further processing (e.g., extending shelf-life). The first inhibitor may inhibit a reaction while a mold is being filled. For example, the mold may have an elevated temperature and the first inhibitor may prevent a reaction beginning until substantially all of the mold is filled. The inhibitors may maintain the resins in a fluid form until the composition is moved into the mold.

The inhibitors may prevent curing when the composition (including the resins) are being added to the mold. A first inhibitor may be gassed off when the composition is added to the mold. For example, the mold may increase the temperature of the composition and the increase in temperature may cause a first inhibitor to escape from the mold, stop inhibiting, or both. A second inhibitor (e.g., a mold inhibitor) may operate at higher temperatures than the injection inhibitor. The second inhibitor may prevent curing until all of the composition is injected into the mold. The second inhibitor may prevent curing until the composition achieves a predetermined temperature that is higher than the injection temperature. The second inhibitor may prevent curing until the composition is increased by about 50° C. or more, about 75° C. or more, about 100° C. or more, or about 125° C. or more. The second inhibitor may prevent curing until the composition is increased by about 300° C. or less, about 250° C. or less, about 200° C. or less, or about 150° C. or less. The second inhibitor may prevent curing until a predetermined temperature is achieved. The second inhibitor may inhibit one or more of the resins or two or more of the resins. The second inhibitor may assist in preventing a reaction from beginning during filling of a mold. The second inhibitor may work with the first inhibitor to prevent a reaction until the mold is substantially full. The second inhibitor may prevent gelling, a skin forming, a partial cross-linking, full curing, or a combination thereof. The second inhibitor may prevent curing before a mold is full so that a surface of a resultant part has a substantially constant surface roughness (or lack of roughness). The second inhibitor may be or include catechols with 3-n-alkyl, 3-isopropyl, 3-phenyl, 4-n-alkyl, 4-isopropyl; or a combination thereof. The second inhibitor may be added with a third inhibitor. The second inhibitor may assist the composition in flowing into the mold.

The third inhibitor functions to inhibit a different resin than the first inhibitor, the second inhibitor, or both. The third inhibitor may restrict one resin while a second resin begins curing. The third inhibitor may allow one resin to begin to cure before a second resin begins to cure. The third inhibitor may prevent both resins from curing until a temperature is achieved, a curing mechanism is introduced (e.g., temperature, moisture, UV. Time, curing component). The third inhibitor ay assist in further inhibiting a reaction as the composition is inserted into the mold. The third inhibitor may be used with the first inhibitor, the second inhibitor, or both. The third inhibitor may be used instead of the first inhibitor or the second inhibitor. The third inhibitor may be catechols with 3,5-dialkyl or 3,6-dialkyl; or both.

The filler functions to enhance thermal conductivity of the BMC. The filler may have a high surface area that fills voids between thermoset resin, reinforcement, thermoplastic resin, or a combination thereof. The filler may be calcium carbonate, talcum powder, barium sulfate, sodium sulfate, magnesium silicate, mica, kaolin, calcium silicate, or a combination thereof. The filler may be inert. The filler may be a mixture of fillers listed herein. The filler may be one of the fillers listed herein. The filler may be present in an amount of about 15 percent or more, about 25 percent or more, about 35 percent or more, about 45 percent or more, or about 55 percent or more by weight of the total weight of the base component. The filler may be present in an amount of about 80 percent or less, 75 percent or less, about 70 percent or less, or about 68 percent or less by weight of the total weight of the base component. The filler may have a medium particle size of about 1 μm or more, about 3 μm or more, about 5 μm or more, or about 8 μm or more. The filler may have a medium particle size of about 20 μm or less, about 15 μm or less, about 12 μm or less, or about 10 μm or less. The filler may have a surface area of about 0.2 m²/g or more, about 0.4 m²/g or more, about 0.6 m²/g or more, or about 0.8 m²/g or more. The filler may have a surface area of about 3.0 m²/g or less, about 2.0 m²/g or less, about 1.8 m²/g or less, about 1.5 m²/g or less, or about 1.2 m²/g or less. The filler may be mixed with a reinforcement material, a mold release, a catalyst, or a combination thereof as part of the composition of the base component.

The mold release agent may function to prevent shrinkage of the composition, the base component, or both. The mold release agent may prevent the composition, the base component, or both from sticking to a mold. The mold release agent may be or include zinc, calcium, antimony, wax, fatty ester, silicone, metallic soap, graphite, vegetable oil, mineral oil, or a combination thereof. The mold release agent may be present in an amount of about 0.2 percent or more, about 0.4 percent or more, about 0.6 percent or more, or about 0.8 percent or more by weight of the total weight of the composition of the base component. The mold release agent may be present in an amount of about 5 percent or less, about 3 percent or less, about 2 percent or less, or about 1 percent or less by weight of the total weight of the composition of the base component. The mold release agent may be zinc antimony or calcium antimony. In addition to a mold release agent the composition may include a shrinkage additive.

The shrinkage additive may prevent the composition from shrinking during molding, curing, cooling, or a combination thereof. The shrinkage additive may reduce a total shrinkage of the base component to be about 20% or less, 15% or less, about 10% or less, about 5% or less, about 3% or less, or about 1% or less. The shrinkage additive may reduce a total shrinkage of about 0.25% or more, about 0.5% or more, about 0.75% or more, about 1% or more, but less than 5%. The shrinkage additive may be present in an amount of about 0.5% or more, about 1% or more, about 3% or more, about 5 percent or more, about 10 percent or more, about 20 percent or more, about 40 percent or more, about 60 percent or more, or even as much as 80% by weight of the total weight of the base component. The shrinkage additive may be made of or include a filler that is free of any shrinkage such that an amount of shrinkage is reduces relative to an all-virgin composition. The shrinkage additive may be or include a PMMA filler, PMMA resin, glass, CaCO3, talcum powder, fiberglass, gravel mineral, recycled thermoset, BMC scrap, PMMA scrap, or a combination thereof. The composition of the base component may include a mold release agent, a shrinkage additive, and a catalyst.

The catalyst functions to start a reaction, drive a reaction, or both. The catalyst may vary depending on the resin being used (e.g., thermoplastic resin or thermoset resin). The catalyst may be or include ketone, cobalt, peroxyester, a methyl ethyl ketone peroxide (MEKP), vinyl ester, or a combination thereof. The catalyst may be present in an amount of about 0.2 percent or more, about 0.4 percent or more, about 0.6 percent or more, or about 0.8 percent or more by weight of the total weight of the composition of the base component. The catalyst may be present in an amount of about 5 percent or less, about 3 percent or less, about 2 percent or less, or about 1 percent or less by weight of the total weight of the composition of the base component.

The reinforcement may strengthen the thermoset resin, thermoplastic resin, filler, or a combination thereof. The reinforcement may intertwine with the thermoset resin, the thermoplastic resin, or both. The reinforcement may be fibers, strands, chopped fibers, a crushed material, or a combination thereof. The reinforcement may be a synthetic material, a natural material, glass, fiberglass, cellulose, carbon fiber, metal fibers, or a combination thereof. The reinforcement may be fibers, chopped fibers, crushed fibers, chopped glass fibers, crushed glass, or a combination thereof. When the reinforcement is a fiber the fiber may have a length of about 1 mm or more, about 3 mm or more, about 5 mm or more, or about 6 mm or more. The fiber may have a length of about 20 mm or less, about 15 mm or less, about 10 mm or less, about 8 mm or less, or about 7 mm or less. The reinforcement may be present in an amount of about 5 percent or more, about 7 percent or more, about 10 percent or more, about 11 percent or more, about 12 percent or more, or about 15 percent or more by weight of the total weight of the composition of the base component. The reinforcement may be present in an amount of about 30 percent or less, about 25 percent or less, about 20 percent or less, about 18 percent or less, about 16 percent or less, about 14 percent or less, about 13 percent or less by weight of the total weight of the composition of the base component. The reinforcement may be uniformly mixed within the composition. The reinforcement may be mixed with binder before the reinforcement is added into the composition.

The binder may function to connect all of the components of the BMC together. The binder may chemically or mechanically connect all of the components together. The binder may act as a glue. The binder may be a natural material, a synthetic material, ethylene vinyl acetate, styrene-butadiene, polyacrylamide, starch, rubber, polyester, or a combination thereof. The binder may be present in an amount of about 1 percent or more, about 2 percent or more, about 3 percent or more, about 4 percent or more, about 5 percent or more, or about 7 percent or more by weight of the total weight of the composition of the base component. The binder may be present in an amount of about 20 percent or less, about 15 percent or less, about 10 percent or less, or about 8 percent or less by weight of the total weight of the composition of the base component. The binder may be a thermoset resin. The binder may be added in addition to the thermoset resin discussed herein. The binder may be the thermoset resin discussed herein. The binder may be mixed with a thermoplastic resin.

The thermoplastic resin may prevent age. The thermoplastic resin may provide some flexibility in the composition of the base component. The thermoplastic resin may assist in releasing compound from a mold. The thermoplastic resin may be present in an amount of about 1 percent or more, about 3 percent or more or about 5 percent or more by weight of the total weight of the composition of the base component. The thermoplastic resin may be present in an amount of about 15 percent or less, about 10 percent or less, about 7 percent or less, or about 6 percent or less by weight of the total weight of the composition of the base component. The thermoplastic resin may be a polycarbonate, acetal copolymer polyoxymethylene, acetal homopolymer polyoxymethylene, acrylic, acrylic-polymethyl methacrylate (PMMA), nylon, polyethylene, polypropylene, polystyrene, polyvinyl chloride (PVC), polytetrafluoroethylene, polyvinyl acetate, saturated polyesters, or a combination thereof. The thermoplastic resin may be a mixture of components herein. The thermoplastic resin may be PMMA. The composition may be a mixture of filler, reinforcement materials, thermal plastic resins, catalyst, release agents, unsaturated resin, or a combination thereof with thermally conductive components. The resin may virgin material, recycled material, or both.

The recycled material may be a cured thermoset. The recycled material may be BMC and PMMA. The recycled material may be only BMC or only PMMA. The recycled material may be a mixture of the BMC and the PMMA such that the total amount of recycled material is equal to the percentages discussed herein. For example, if the total amount of recycled material is ten percent then the recycled material may be BMC at 2 percent and PMMA at 8 percent, or if the BMC is at 3 percent then the PMMA is at 7 percent. The recycled material may include PMMA in an amount of up to about 6 percent. The recycled material may include BMC in an amount of up to about 5 percent. The recycled material may replace filler material. The recycled material may reduce a specific gravity of the final composition or final product. The recycled material may be added as a filer. The recycled material may have a lower specific gravity than a traditional filler (e.g., calcium, carbonate).

The recycled material may be post-consumer material, post-industrial material, or both. The recycled material may be material that has been fully processed, cured, thermoset, or a combination thereof. The recycled material may be material that has been cured (e.g., is thermoset). The recycled material may be material that is permanently fixed. The recycled material may be resins that have been cured so that irreversible bonds are created inside of a body component. The recycled material may be material from before a coating is applied. The recycled material may be only material with the base component.

The recycled material may be processed before the recycled materials are added into the composition. The recycled material may be processed by cutting, grinding, crushing, milling, ball milling, pulverizing, shredding, granulating, blending, grinding, regrinding, or a combination thereof. The recycled material may be screened, classified, sorted, or a combination thereof. The screening may remove particles above a certain size. The screening may pass particles below a predetermined size into the composition and particles above a predetermined size back for further processing. The particle size provided to the composition my be about 15 μm or more, about 20 μm or more, about 25 μm or more, about 30 μm or more, about 35 μm or more, about 40 μm or more, about 45 μm or more, or about 50 μm or more. The particle size provided to the composition may be about 150 μm or less, about 125 μm or less, about 100 μm or less, about 75 μm or less, or about 50 μm or less. The screened material may be directly provided into the composition. The screened material may be dissolved and added in as a resin or a fluid material. The screened material may be dissolved in a homopolymer. The screened material may be dissolved in styrene. Some of the screened material recycle may be added as a ground up solid and some of the screen material may be dissolved and added as a liquid.

The recycled material may be added in an amount of about 1 percent or more, 5 percent or more, 10 percent or more, or even 20 percent or of a total weight of the base component. The recycled material may be added in an amount of about 50 percent or less, about 40 percent or less, about 30 percent or less, or about 20 percent or less of a total weight of the base component. The recycled material may be present in a sufficient amount that an amount of shrinkage is reduced relative to a base component that is free of recycled material. The recycled material may be present in a sufficient amount so that the base component shrinks by about 20 percent or less, about 15 percent or less, about 10 percent or less, about 5 percent or less, or about 1 percent or less. The recycled material may be added in place of filler, resin, or both. The recycled material may be provided in place of calcium carbonate. The particles of the recycled material may be harder than the particles of filler (e.g., calcium carbonate). The hardness of the recycled materials prevents the recycled materials from being forced out of the space in the mold (e.g., whereas other fillers may be forced out of the space in the mold). The hardness of the recycled material may be sufficiently high so that the recycled materials create a dam and are retained within the mold. The hardness of the recycled material (e.g., ground up BMC or PMMA) may be about 3 Mohs or more, about 4 Mohs or more, about 5 Mohs or more, or about 6 Mohs or more. The hardness of the recycled material may be about 7 Mohs or less, about 6 Mohs or less, or about 5 Mohs or less. The recycled material may flow within a mold when the composition is injected into the mold.

The recycled materials may be mixed into the composition. As the composition is injected into a mold some of the composition may flow towards edges and/or seams in the mold. For example, if a clamshell mold is used, when the mold is closed, a seam may extend around the mold so that a part may be removed when the composition hardens. The recycled material may contact the seam and prevent composition from extending through the seam. The recycled material may create dams within the mold so that voids in the mold are filled and material is prevented from flowing through the voids. The recycled material may prevent flash, prevent material from exiting the mold, extending into the seam, or both. The recycled material may fill internal voids in the composition as the composition extend into the mold so that a smooth outer surface is formed. The recycled material may extend to an exterior of the base component. The recycled material may be located below an outer surface of the base component such that the recycled material does not form any portion of the outer surface. The recycled material may form a portion of the outer surface but the particle size may be sufficiently small that the virgin material and the recycled material are coplanar such that the recycled material does not adversely change surface roughness. The virgin material may extend around the recycled material so that when the composition contacts an interior surface of the mold, the recycled material and the virgin material are smooth, form a smooth exterior, or both. The surface roughness below are from the prior case. Do we have new ones?

The base component has a surface roughness. The surface roughness may be sufficiently smooth so that one or more coatings may be applied (e.g., directly) on the base component. The surface roughness may be sufficiently smooth so that a basecoat is not needed to adhere a coating to the base component. The surface roughness may be about 10 nm or more, about 20 nm or more, about 30 nm or more, about 40 nm or more, about 50 nm or more, or about 75 nm or more. The thermally conductive material may be coated. The surface roughness may be about 200 nm or less, about 150 nm or less, about 125 nm or less, about 100 nm or less, about 75 nm or less, or about 50 nm or less (e.g., between about 83 nm and about 96 nm and preferably about 50 nm and 25 nm). Preferably, the surface roughness is about 30 nm or less.

The coating may be directly applied to the base component. The coating may be reflective, thermally conductive, or both. The coating may be applied directly on the base component without any intervening components or base coatings. The coating may be applied to the base component without any basecoat. The coating may be directly applied to base component.

The coating may be applied to the base component after the base component is molded into a final shape. The coating may be applied directly to the final shape. The coating may be disposed on the final shape via any disposition technique. The coating may be disposed by spraying, electrostatic disposition, metallization, vacuum, vacuum metallization, spin coating, arc spraying, flame spraying, plating, electroless plating, or a combination thereof. The coating may be or include aluminum, chrome, silver, or a combination thereof. The coating may provide reflection, thermal conductivity, or both to the body, the body composition material, or both. The coating may provide reflectivity.

The teachings herein create a lighting component with one or more base components that may be made by one of more steps taught herein. The lighting component may be virtually any part of the lighting system. The base components may be a reflector. The process may begin by forming an article of manufacture (e.g., a body). A base material may be mixed together. The base components may include a BMC. The composition may be formed into a body. The composition material may be formed into a body by extrusion, pultruding, molding, compressing molding, melt molding, transfer molding, injection molding, or a combination thereof. The body may be free of any post forming steps. The body may be free of any sanding, spraying, smoothing, surface treatment, or a combination thereof. The body may be free of flashing removal. The body may be moved directly from a forming step to coating. The coating may be applied directly on the base components. One or more masks may be applied to the base components before the coating is applied so that one or more areas may be free of the coating. The base components may be free of a base coat.

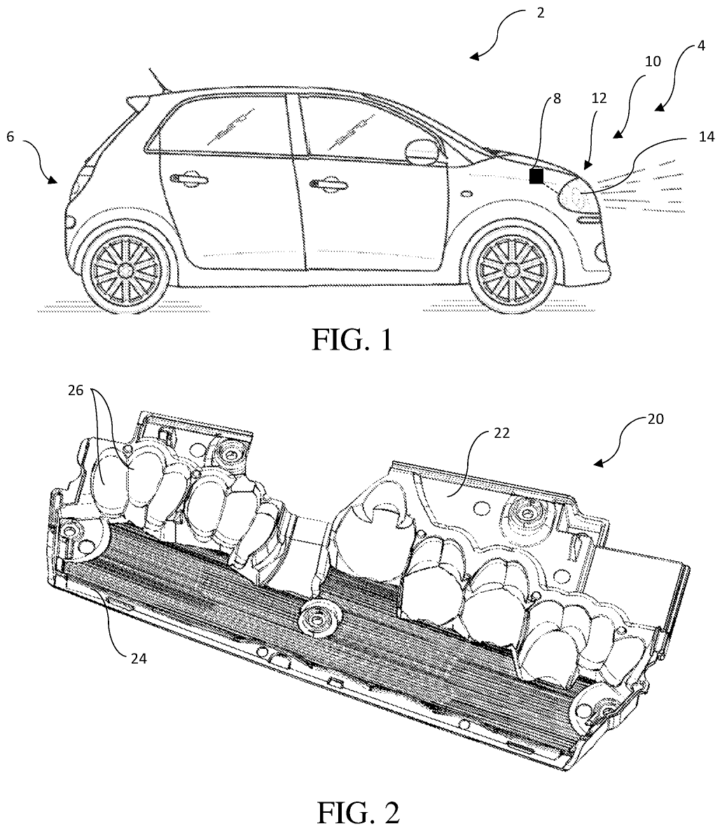

FIG. 1 illustrates a side view of a vehicle 2 including light systems 10. The light systems 10 provide light around the vehicle 2. The light systems 10 are located at a fore 4 end of the vehicle 2 but could be located at an aft 6 of the vehicle 2. The light systems 10 include a body 12 with an outer lens 14. The light systems 10 may be controlled by one or more controllers 8 jointly or individually.

FIG. 2 is an isometric view of a body component 20. The body component 20 as shown is a reflector 22. The reflector 22 supports a printed circuit board (PCB) 24 and includes a plurality of reflector pockets 26. The reflector pockets 26 are aligned relative to light sources that redirect light to a location of interest. The body component 20 is made from the composition discussed herein.

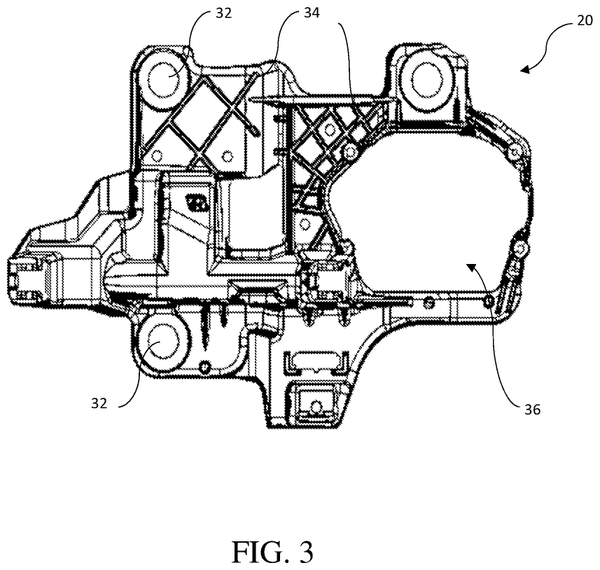

FIG. 3 is a side plan view of an example body component 20. The body component 20 as shown is a bracket 30. The bracket 30 includes bosses 32 to connect the bracket 30 within a vehicle. The bracket 30 has ribs 34 to provide rigidity to the bracket 30, and a connection recess 36 to connect the bracket 30 to one or more other lighting components. The body component 20 is made from the composition discussed herein.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of or even consists of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

We claim:

1. A body composition comprising:
a bulk molded compound (BMC) comprising:
one or more thermoset resins;
one or more fillers;
one or more reinforcements;
one or more binders;
two or more inhibitors; and
recycled body composition materials (recycled BMC);
wherein the recycled BMC is a cured material that is processed and added into the body composition.

2. The body composition of claim 1, wherein recycled BMC is added in an amount of about five percent or more of a total weight of the body composition.

3. The body composition of claim 2, wherein the recycled BMC comprises a cured bulk molded compound resin material.

4. The body composition of claim 2, wherein the recycled BMC comprises a cured poly(methyl methacrylate) PMMA resin material.

5. The body composition of claim 1, wherein the recycled BMC comprises a mixture of a cured bulk molded compound resin material and a cured poly(methyl methacrylate) PMMA resin material.

6. The body composition of claim 5, wherein the recycled BMC is present in an amount of about ten percent or more of a total weight of the body composition.

7. The body composition of claim 1, wherein the reinforcement is chopped glass fibers and crushed glass and the reinforcement is present in an amount from about 5 percent or more to about 30 percent or less by weight of the total weight of the BMC.

8. The body composition of claim 1, wherein the two or more inhibitors are three different inhibitors.

9. A lighting component comprising:
a body component comprising:
a body composition comprising:
a bulk molded compound resin (BMC);
one or more fillers;
two or more inhibitors; and
recycled body composition materials (recycled BMC);
wherein the recycled BMC is cured material of the body composition that is processed and added into the body composition.

10. The lighting component of claim 9, further comprising:
a coating located directly on the body component so that the coating connects directly to the body component.

11. The lighting component of claim 9, wherein the recycled BMC is present in an amount of about 5 percent or more and about 20 percent less of the total weight of the body composition.

12. The lighting component of claim 1, wherein the recycled BMC comprises a mixture of a cured bulk molded compound resin material and a cured poly(methyl methacrylate) (PMMA) resin material.

13. The lighting component of claim 9, wherein the recycled BMC has a hardness that is three Mohs or more.

14. The lighting component of claim 10, wherein the body composition is free of a base coat between the body composition and the coating.

15. The lighting component of claim 14, wherein the one or more fillers comprise clay, talc, alumina trihydrate, glass, or a combination thereof.

16. The lighting component of claim 15, wherein the one or more fillers are present in an amount from about 40 percent to about 80 percent by weight of the BMC.

17. The lighting component of claim 16, wherein recycled BMC is added as one of the one or more fillers.

18. The lighting component of claim 9, wherein the body composition comprises virgin poly(methyl methacrylate) PMMA resin in addition to the BMC resin.

19. A process comprising:
forming a bulk molded compound (BMC) comprising:
one or more thermoset resins;
one or more fillers;
one or more reinforcements; and
one or more binders;
combining the bulk molded compound with recycled body composition materials (recycled BMC), that has been cured, to form a body composition;
molding the body composition into a body component of a lighting component; and
curing the BMC.

20. The process of claim 19, further comprising:
processing the recycled BMC by reducing a size of the recycled BMC,
wherein the recycled BMC is present in an amount of about 5 percent or more and about 20 percent less of the total weight of the body composition.
